(19) United States
(12) Patent Application Publication
(10) Pub. No.: US 2013/0332130 A1
(43) Pub. Date: Dec. 12, 2013

(54) Method for Analyzing Water and Preparing Oilfield Fluids Therefrom

(71) Applicants: David M. Loveless, Houston, TX (US); Arron Karcher, Duncan, OK (US)

(72) Inventors: David M. Loveless, Houston, TX (US); Arron Karcher, Duncan, OK (US)

(73) Assignee: HALLIBURTON ENERGY SERVICES, INC., Houston, TX (US)

(21) Appl. No.: 13/492,856

(22) Filed: Jun. 9, 2012

(51) Int. Cl. G06G 7/48

(52) U.S. Cl. 703/10

(57) ABSTRACT

The present invention is directed to a method of preparing aqueous fluids for use in a hydrocarbon well. The method includes analyzing a water sample to produce a profile including at least one analyte concentration of the water sample, inputting at least a portion of the profile into a formulation database, wherein the formulation database generates an fluid model including at least one recommendation for the fluid composition of the aqueous fluid for use in the hydrocarbon well.

### FIELD OF THE INVENTION

The present invention relates generally to the production of hydrocarbon production stimulation fluids, and more particularly to a method of producing fracturing fluids based on the analysis of water from one or more sources.

### BACKGROUND OF THE INVENTION

Water, originating from a multitude of sources, can be a vital component of many oilfield operations. Water may be transported to the oilfield site for various purposes, including drilling mud, formation fracturing, enhanced oil recovery including steam injection, and the like. In addition to the desired hydrocarbons, many oil and natural gas producing wells also generate large quantities of waste water, commonly referred to as “produced water.” Produced water typically is contaminated with significant concentrations of chemicals and other substances requiring that the produced water be treated before being reused or discharged to the environment. Such contaminants may include natural contaminants originating from the subsurface environment, such as hydrocarbons from the oil- or gas-bearing strata and inorganic salts, and may also include man-made contaminants, wherein the man-made contaminants typically originate from injection of chemicals and other substances into the wells as part of the drilling and production processes and are subsequently recovered as contaminants in the produced water. Such man-made contaminates can include drilling mud; “frac flow back water” that includes spent fracturing fluids including polymers and inorganic cross-linking agents; polymer breaking agents; friction reduction chemicals; and artificial lubricants.

Because of the economic factors present in transporting uncontaminated water to the well site and the typically abundant supply of produced water generated on site, it is desirable to reuse the produced water in production operations at the well site. For example, produced water can be typically used in production stimulation treatment, which involves in one method fracturing the formation utilizing a viscous treating fluid, typically a fracturing gel, wherein the subterranean formation or producing zone is hydraulically fractured whereby one or more cracks or “fractures” are produced. In such a method, the produced water may be used as fracturing feed water, commonly referred to as “frac water.” The fracturing (“frac”) gel is created by combining frac water with a polymer, such as guar gum, and in some applications a cross-linker, typically borate-based, to form a fluid that gels upon hydration of the polymer. Several chemical additives generally can be added to the frac gel to form a treatment fluid specifically designed for the anticipated wellbore, reservoir and operating conditions.

Because of the very wide range of contaminant species as well as the different quality of produced water from different sources, the produced water must be analyzed to determine the contaminants and other impurities present. The types and concentrations of the contaminants discovered in the produced water will typically determine the treatment and/or additives to be applied to the produced water to create a fracturing gel having the specific properties required to properly fracture the intended formation. In a conventional process, a sample of the produced water is submitted for laboratory analysis and subsequently a fracturing fluid formulation is created based on the analysis of the produced water sample. The analysis may take place onsite or at a laboratory offsite depending on the facilities available at the well site. Generally, personnel specifically trained to operate the extensive laboratory equipment must be employed to accurately analyze the production water sample. Additionally, such onsite laboratory equipment typically requires extensive technical support, sufficient infrastructure, transportation means, and sufficient space to operate. Such space may be unavailable, particularly on offshore facilities, where additional space requires substantial economic investment in the platform or rig. Furthermore, additional manpower required to operate the laboratory equipment offshore can result in higher operating costs for the operator of the well. Thus, the water sample is typically analyzed in a laboratory setting offsite.

Another problem associated with the submission of production water samples for analysis, particularly to an offsite laboratory, is the length of time required to obtain verification of the sample composition. In many oilfield operations, operating costs can be thousands of dollars per hour. Having a workover rig experience downtime while waiting on laboratory results for the production water sample can be economically undesirable. Furthermore, in remote onshore and offshore well sites, a significant delay in production can result from the delay in waiting for a produced water sample to arrive at the laboratory and for the laboratory to process the sample. Such delays are commonly incurred while waiting for the formulation of the fracturing fluid based on the analysis of the produced water sample.

Thus, a need exists for a time-efficient and useful method to analyze produced water samples at the well site. More specifically, there is a need for a method of analyzing produced water samples, wherein the samples may be analyzed with an expeditious turnaround time in addition to a formulation of the fracturing fluid without the need for extensive laboratory equipment. There is a need for the analysis of the water sample to be conducted by a worker at the well site without extensive laboratory training.

### BRIEF DESCRIPTION OF DRAWINGS

FIG. 1 is a simplified schematic diagram illustrating a method for preparing an aqueous oilfield fluid consistent with one embodiment of the present invention.

FIG. 2 is an illustration of an analyte matrix profile consistent with one embodiment of the present invention wherein.

FIG. 3 is a graph of fluid properties from a model consistent with one embodiment of the present invention.

### DETAILED DESCRIPTION

The present invention is directed to a method of producing fracturing fluids based on the well site analysis of water from one or more sources. In its most basic form, the present invention achieves its goal by providing at least one water sample, analyzing the water sample at the well site or a location proximate the well site for types and quantities of contaminants or other impurities, inputting the results of the analysis into a predictive modeling system, and formulating a fracturing fluid composition based on the predictive modeling system. As used herein, the terms “contaminants” and “impurities” may be used interchangeably to include any non-water molecule components found in the water sample. Additionally, as used herein, the location proximate to the well site can be a remote laboratory facility accessible to the operator of the well site without substantial loss of well operating time. As those of ordinary skill in the art will appreciate from the disclosure that follows, there are many different ways of analyzing the water samples for types and quantities of contaminants or other impurities, many different ways of modeling the predictive modeling system, and many different ways of formulating a fracturing fluid composition based on the predictive modeling system. A number of exemplary ways of performing these functions are disclosed herein.

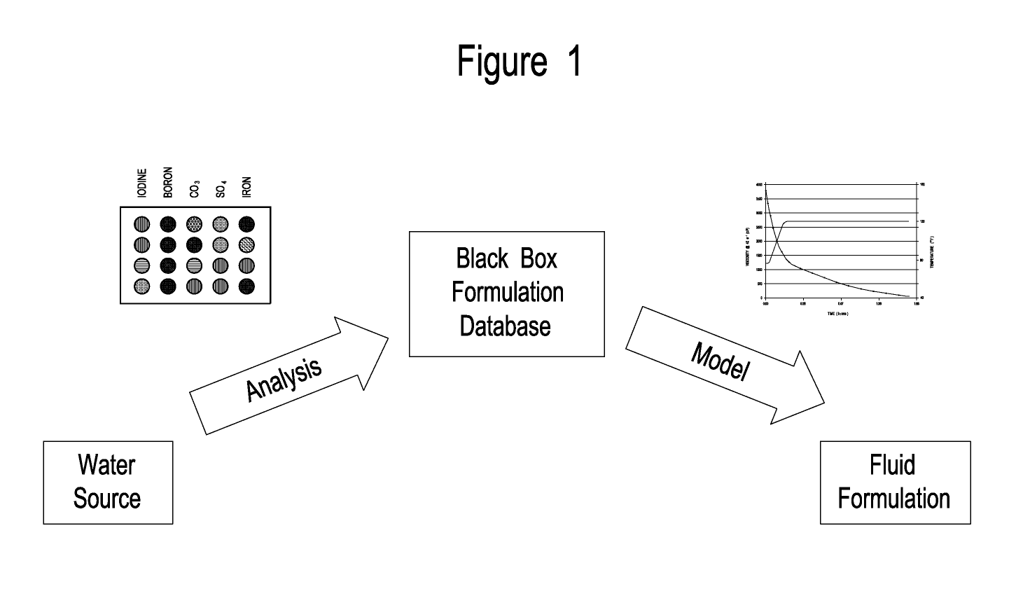

Turning now to the Figures, a simplified schematic of one embodiment of the present invention is illustrated in FIG. 1, wherein a process for analyzing a sample of water derived from at least one source and formulating a fracturing fluid based on the analysis of the water sample is depicted in simplified form. In the embodiment illustrated, a water source is shown wherein a sample of water is provided therefrom. In an alternate embodiment, a water sample can be provided from at least one water source. The water sample can be provided from a plurality of water sources, wherein the water sources may be separate and distinct or the water sources may comingle. The water source can include water generated by oil and natural gas production, water utilized in the production of oil and natural gas, and water transported to the well site. Nonlimiting examples of a water source include water produced from the formation, flowback, steam injections, waterflooding, drilling mud, water tanks, and the like. The water source may be generated from the well site. Optionally, the water source may be generated from a neighboring well site, from a pipeline, or from a water tank transported to the well site. Those of ordinary skill in the art will understand the foregoing to be nonlimiting examples, and other water sources may be considered within the scope of the present invention.

As used herein, the term “flowback” will be understood to mean the process of allowing fluids to flow from the well following a treatment, either in preparation for a subsequent phase of treatment or in preparation for cleanup and returning the well to production. One example of treatment employed within the scope of the present invention is hydraulic fracturing. The term “hydraulic fracturing” as used herein refers to the injection of a viscous fracturing fluid into a subterranean formation or zone at a rate and pressure sufficient to cause the formation or zone to break down with the attendant production of one or more fractures. The continued pumping of the viscous fracturing fluid extends the fractures, and a proppant such as sand or other particulate material may be suspended in the fracturing fluid and introduced into the created fractures. The proppant material functions to prevent the formed fractures from closing upon reduction of the hydraulic pressure which was applied to create the fracture in the formation or zone whereby conductive channels remain through which produced fluids can readily flow to the well bore upon completion of the fracturing treatment.

Depending on the water source, the sample of water can contain contaminants or other impurities, wherein the contaminants can originate from natural sources or man-made sources. For example, a sample of water taken from a water source utilized in high-viscosity fracturing operations can contain gellants in the form of polymers with hydroxyl groups, such as guar gum or modified guar-based polymers; cross-linking agents including borate-based cross-linkers; non-emulsifiers; and sulfate-based gel breakers in the form of oxidizing agents such as ammonium persulfate. A sample of water taken from a water source utilized in drilling fluid treatments can include acids and caustics such as soda ash, calcium carbonate, sodium hydroxide and magnesium hydroxide; bactericides; defoamers; emulsifiers; filtrate reducers; shale control inhibitors; deicers including methanol and thinners and dispersants. Also, a sample of water taken from a water source utilized in slickwater fracturing operations can include viscosity reducing agents such as polymers of acrylamide.

The water sample can include other impurities from one or more water sources that can affect the formulation of fracturing fluids. In at least one embodiment, the water sample includes one or more impurities from the group of boron, iron, iodine, calcium, sulfate, chloride, phosphate, magnesium, potassium, strontium, aluminum, bicarbonate, hydroxide, carbonate, arsenic, barium, bromine, chromium, cobalt, copper, manganese, nickel, silica, titanium, vanadium, zinc, zirconium, and combinations thereof. Such impurities may naturally occur in the water source or may be introduced by activities related to oil and natural gas production. The water sample can include impurities having a buffering capacity of about 2 to about 3.5. Optionally, the water sample can include impurities having a buffering capacity of about 6.0 to about 7.2. Optionally, the water sample can include impurities having a buffering capacity of about 7.8 to about 8.8. In an alternate embodiment, the water sample includes impurities having organic content.

In the illustrated embodiment of FIG. 1, the water sample is provided from the water source and is analyzed using a chemical analytical procedure to determine the analytes of the water sample, wherein the analytes of the water sample include the impurities found therein. The analysis can be conducted at the well site. Optionally, the analysis of the water sample can be conducted at a facility proximate the well site. In an embodiment of the present invention, the analytical procedure utilized is a combinatorial chemistry matrix to provide an analyte matrix profile. The combinatorial chemistry matrix can be constructed utilizing various methodologies. In one embodiment, the analysis performed can be a simplified colormetric screening process, wherein pre-determined analyte concentration ranges can be identified.

The colormetric screening process can be carried out utilizing numerous techniques. In an exemplary technique, a reaction plate is utilized wherein a series of small reactions are conducted to produce a colored response indicator corresponding to a known analyte concentration. In this technique, reagents are added to the water sample so that a chemical reaction occurs wherein an analyte present causes a color change thereby providing an indicator that may be discerned visually to indicate the analyte and corresponding concentration in the water sample. When discerning visually, a reference scale may be used to determine the analyte and corresponding concentration. Typically, the intensity of the color reaction is directly proportional to the concentration of the analyte tested.

In an alternate embodiment, the analysis performed can be a simplified titration process, wherein pre-determined analyte concentration ranges can be identified. For example, the titration process can be similar to the titration process utilized in swimming pool test kits. In the titration process, the water sample is titrated until the color changes, with the number of drops consumed to the turning point or the scalar value read off from a pipette, or similar titration tool, corresponding to the concentration of the tested analyte.

It will be understood by one of ordinary skill in the art that other conventional analysis techniques may be employed to analyze the water sample in an efficient and simplistic manner at or proximate the well site. One nonlimiting example includes analyzing light transmittance. In such an analysis, an optical reader, such as a colorimeter or filter photometer, is used to evaluate the color reaction according to the transmitted light method. A light beam is passed through the sample, and the amount of light transmitted depends on the amount of color present in the sample. For example, if the sample is very dark in color, limited light will pass through, which indicates a high chlorine concentration.

As stated above, one of ordinary skill in the art will understand that numerous conventional analysis techniques may be employed to analyze the water sample in an efficient and simplistic manner at or proximate the well site. In an exemplary embodiment, the analysis technique is capable of determining the concentrations of the analytes selected from boron, iron, iodine, calcium, sulfate, chloride, phosphate, and combinations thereof. Additionally, in an alternate embodiment, the analysis technique can determine properties of the water sample including specific gravity, pH, resistivity, temperature, ionic strength, total dissolved solids (TDS), total suspended solids (TSS), total organic carbons (TOC), and chemical oxygen demand (COD). The analysis technique is also capable of determining buffering capacity and total organic content. The analysis technique employed can be based on the ability of the technique to discern concentration amounts based on analyte sensitivity. For example, boron concentrations may need to be known every 25 ppm, whereas with sodium it may only be necessary to distinguish every 5000 ppm. Optionally, the analysis method performed can be selected by the well site operator based on various factors, including costs, efficiency, available testing material, and the like.

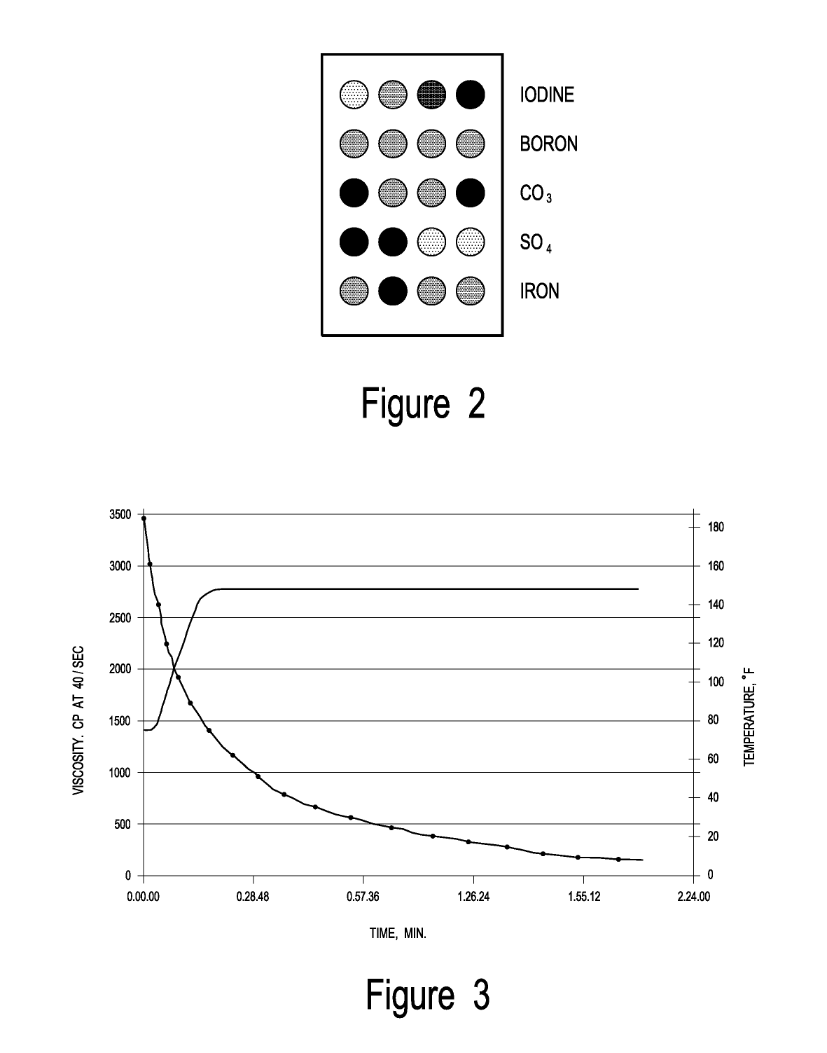

In an exemplary embodiment, the analytical procedure utilized is a combinatorial chemistry matrix to provide an analyte matrix profile as shown in FIG. 1 and in more detail in FIG. 2. The analyte matrix profile can include various arrangements and properties. In an exemplary embodiment, the analyte matrix includes the type of analyte and the concentration of each analyte. In an embodiment, the analyte matrix profile includes the concentration of boron, iron, iodine, calcium, sulfate, chloride, and phosphate. In an embodiment, the analyte matrix includes buffering capacity and total organic content of the sample. The format of the analyte matrix profile can be based at least in part on the input format required for the formulation database, which will be further discussed below. Optionally, the format of the analyte matrix profile can be based on the needs and preferences of the well site operator.

In an exemplary embodiment, the analytical procedure generates an analyte matrix profile, wherein the analyte matrix profile is entered into a portion of a predictive modeling system illustrated as a formulation database in FIG. 1. The analyte matrix profile may be automatically entered upon generation by the analytical procedure. For example, the analyte matrix profile may be generated in electronic data format compatible with the formulation database, whereby the electronic data from the analyte matrix profile may be sent upon generation to the formulation database. Such transmittal may be accomplished by conventional methods known to one of ordinary skill in the art. Optionally, the analyte matrix profile may be entered manually by an operator of the well site, wherein the data from the analyte matrix profile may be entered by keyboard or other conventional methods known to those skilled in the art.

In an exemplary embodiment, data regarding information and properties of the well to be treated and desired properties of the oilfield fluid composition are entered into the formulation database. The well data may be entered manually utilizing methods discussed above regarding the analyte matrix profile or the data may be entered automatically through the use of sensors or other electronic methods. For example, the formulation database may be in electronic communication with sensors capable of determining well temperature and pressure. Optionally, the data may be entered automatically, manually, and or in combinations thereof. Well data entered into the formulation database for the well to be treated can include temperature and pressure. Desired fluid properties of the oilfield fluid composition can also be entered, wherein the desired fluid properties can include pH, initial viscosity, viscosity delay slope, final broken viscosity, sand transport time, onset of crosslinking, type of gelling agent, type of crosslinker, type of breaker, types of other additives (scale inhibitor), type of biocide, type of paraffin control, type of clay control, and combinations thereof.

In an exemplary embodiment, the formulation database generates a fluid model, wherein the fluid model can be utilized to formulate a fluid composition, which will be discussed in further detail below. The formulation database includes physical and chemical properties related to the analytes and the well to be treated. The formulation database can also include fundamental physical and chemical relationships, empirical evidence, algorithms based on testing results, and the like. In an embodiment, the formulation database is in an electronic format and can be located on a computer at the well site. Optionally, the formulation database can be hosted on a remote server accessible by a computer located at the well site.

In an exemplary embodiment, the formulation database generates a fluid model as shown in FIG. 1 and in more detail in FIG. 3, wherein the fluid model can be utilized to formulate a fluid composition. Specifically, the fluid model provides a recommendation on the composition of the formulation fluid to be used. The recommendation can include concentration of gelling agent, concentration of crosslinker, concentration of buffers, concentration of breaker, concentration of other additives, and combinations thereof. The fluid model may be generated in various formats. In an embodiment, the fluid model may be generated in a spreadsheet format, a report format, a graphical format, a tabular format, and combinations thereof. The fluid model can be in an electronic format and can be located on a computer at the well site. Optionally, the formulation database can be hosted on a remote server accessible by a computer located at the well site. The computer can be operatively connected to at least one fluid producing device, wherein one or more signals generated by the computer in reference to the fluid model can include instructions on fluid composition to be generated by the fluid producing device.

In an exemplary embodiment, at least one recommendation included in the fluid model generated by the formulation database is acted upon by the operator of the well site to produce a fluid composition suitable for use as a fracturing fluid. In an embodiment, the fracturing fluid will have one or more of the following properties configured according to the recommendations provided in the oilfield fluid model: pH, initial viscosity, viscosity delay slope, final broken viscosity, sand transport time, onset of crosslinking, type of gelling agent, type of crosslinker, type of breaker, types of other additives (scale inhibitors), type of biocide, type of paraffin control, type of clay control, and combinations thereof.

### Example

The following example is illustrative of the principles of this invention. It is understood that this invention is not limited to any one specific embodiment exemplified herein, whether in the example or the remainder of this patent application.

In an example of an embodiment of the present invention, a well drilled in the Bakken formation was chosen for production stimulation treatment. The stimulation treatment provided for the well included hydraulic fracturing. At least one formation intersected by the wellbore was fractured through the utilization of a fracturing gel. The fracturing gel included fracturing feed water or “frac water” combined with additives, discussed below, which were added to the fracturing feed water based at least in part on the properties of the fracturing feed water, the formation, and the wellbore.

The fracturing feed water was provided from a water source proximate the well site. More specifically, the water source was the water that had been retrieved from the well ‘flowback water’. A water sample was taken from the water source and submitted to a offsite analytical laboratory, wherein the water sample was analyzed utilizing a multiple analytical techniques to provide an analyte matrix profile. The analyte matrix profile can include the type of analyte found and the concentration of each analyte. In addition to the analyte matrix profile, other properties of the water sample were analyzed including specific gravity, pH, resistivity, temperature, ionic strength, total dissolved solids (TDS), total suspended solids (TSS), total organic carbons (TOC), and chemical oxygen demand (COD).

The analyte matrix profile and the other determined properties of the water sample were input in a formulation database in addition to data regarding information and properties of the well to be treated and the desired properties of the fracturing fluid composition. Properties of the well included temperature and pressure at formation depth. The desired properties of the fracturing fluid included pH, initial viscosity, viscosity delay slope, final broken viscosity, sand transport time, onset of crosslinking, type of gelling agent, type of crosslinker, type of breaker, types of other additives (scale inhibitor), type of biocide, type of paraffin control, and type of clay control.

The formulation database processed the inputted data and generated a fluid model output, wherein the output included a graph including a comparison of the relationship of the viscosity of the fracturing fluid over a temperature and period of time for varying fracture fluids is shown in FIG. 3.

While the invention has been depicted, described, and is defined by reference to exemplary embodiments of the invention, such a reference does not imply a limitation on the invention, and no such limitation is to be inferred. The invention is capable of considerable modification, alteration, and equivalents in form and function, as will occur to those ordinarily skilled in the pertinent arts and having the benefit of this disclosure. For example, as those of ordinary skill in the art will appreciate, the exact number, size and order of the transverse fractures formed is not critical. The depicted and described embodiments of the invention are exemplary only, and are not exhaustive of the scope of the invention. Consequently, the invention is intended to be limited only by the scope of the appended claims, giving full cognizance to equivalents in all respects.

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Other and further embodiments, versions and examples of the invention may be devised without departing from the basic scope thereof and the scope thereof is determined by the claims that follow.

While compositions and methods are described in terms of “comprising,” “containing,” or “including” various components or steps, the compositions and methods can also “consist essentially of” or “consist of” the various components and steps. Use of the term “optionally” with respect to any element of a claim is intended to mean that the subject element is required, or alternatively, is not required. Both alternatives are intended to be within the scope of the claim.

All numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A method of preparing aqueous fluids for use in a hydrocarbon well, the method comprising
analyzing a water sample at the hydrocarbon well site or at a location proximate the hydrocarbon well site using a chemical analytical procedure to produce a profile comprising a concentration of at least one analyte in the water sample, wherein the water sample is provided from at least one water source;
inputting at least a portion of the profile and at least one hydrocarbon well property into a formulation database, wherein the formulation database generates a fluid model including at least one recommendation for the fluid composition of the aqueous fluid for use in the hydrocarbon well; and
formulating the fluid composition of the aqueous fluid for use in the hydrocarbon well based on the recommendation in the fluid model.

2. The method of claim 1, wherein the location proximate the hydrocarbon well site is a field laboratory.

3. The method of claim 1, wherein the chemical analytical procedure is a combinatorial chemistry matrix and the profile produced is an analyte matrix profile.

4. The method of claim 3, wherein the combinatorial chemistry matrix comprises a colormetric screening process, wherein pre-determined analyte concentration ranges can be identified.

5. The method of claim 4, wherein the colormetric screening process comprises one or more reagents added to the water sample so that a chemical reaction occurs wherein an analyte present causes a color change thereby providing an indicator that may be discerned visually to indicate the analyte and corresponding concentration in the water sample.

6. The method of claim 1, wherein the recommendation is selected from the group consisting of concentration of gelling agent, concentration of crosslinker, concentration of buffers, concentration of breaker, concentration of other additives, and combinations thereof.

7. The method of claim 1, wherein the hydrocarbon well property is temperature and/or pressure.

8. The method of claim 7, wherein the desired fluid properties are selected from the group consisting of initial viscosity, viscosity delay slope, final broken viscosity, sand transport time, onset of crosslinking, type of gelling agent, type of crosslinker, type of breaker, types of scale inhibitors, and combinations thereof.

9. The method of claim 1, wherein the analyte is selected from the group consisting of boron, iron, iodine, calcium, sulfate, chloride, phosphate, and combinations thereof.

10. The method of claim 1, wherein the water source is selected from the group consisting of produced water, flowback, drilling fluids, and combinations thereof.

11. The method of claim 1, wherein the aqueous fluid comprises stimulation treatment fluid.

12. A method for formulating a stimulation treatment fluid for a hydrocarbon well, the method comprising
generating at least one recommendation based on a model created by a database, wherein the database creates the model based on at least one input indicative of the concentration of at least one analyte, the input determined from a water sample subjected to an analytical procedure at the hydrocarbon well site or at a location proximate the well site; and
formulating the stimulation treatment fluid for use in the hydrocarbon well based on the recommendation derived from the model.

13. The method of claim 12, wherein the recommendation is further based on properties of the hydrocarbon well and desired properties of the stimulation fluid, the properties of the hydrocarbon well comprising temperature and pressure.

14. The method of claim 12, further comprising analyzing the water sample subjected to the analytical procedure, wherein the analytical procedure comprises a combinatorial chemistry matrix.

15. The method of claim 12, wherein the analytical procedure comprises a colormetric screening process, whereby the concentration of the analyte can be identified.

16. The method of claim 12, wherein the analyte is selected from the group consisting of boron, iron, iodine, calcium, sulfate, chloride, phosphate, and combinations thereof.

17. The method of claim 12, wherein the location proximate the hydrocarbon well site is a field laboratory.

18. The method of claim 12, wherein the water sample is collected from a water source selected from the group consisting of produced water, flowback, water tanks, drilling fluids, and combinations thereof.

19. A method for formulation a fracturing fluid for use in a hydrocarbon well, the method comprising
providing a water sample for analysis at the hydrocarbon well site or at a location proximate the hydrocarbon well site, wherein the water sample is collected from at least one water source;
analyzing the water sample at the hydrocarbon well site or the location proximate the hydrocarbon well site using a combinatorial chemistry matrix to produce a analyte matrix profile comprising the concentration of at least one analyte in the water sample;
inputting at least a portion of the analyte matrix profile and at least one hydrocarbon well property and, optionally, at least one desired property of the fracturing fluid into a formulation database, wherein the formulation database generates a fluid model including at least one recommendation for the composition of the fracturing fluid for use in the hydrocarbon well; and
formulating the fracturing fluid for use in the hydrocarbon well based on the recommendation in the fluid model,
wherein the analyte is selected from the group consisting of boron, iron, iodine, calcium, sulfate, chloride, phosphate, and combinations thereof.

20. The method of claim 19, wherein the combinatorial chemistry matrix comprises a colormetric screening process, wherein the colormetric screening process comprises
contacting at least one reagent with at least a portion of the water sample;
observing the portion of the water sample for a change in the color of the portion of the water sample; and
determining the concentration of the analyte based on the change in color of the portion of the water sample.
